(19) United States
(12) Patent Application Publication
(10) Pub. No.: US 2025/0031927 A1
(43) Pub. Date: Jan. 30, 2025

(54) DIRT SEPARATOR

(71) Applicant: Dyson Technology Limited, Malmesbury, Wiltshire (GB)

(72) Inventor: Andrew John ISAACS, Tetbury (GB)

(21) Appl. No.: 18/710,741

(22) PCT Filed: Nov. 7, 2022
(86) PCT No.: PCT/GB2022/052803

§ 371 Date: May 16, 2024

(30) Foreign Application Priority Data
Nov. 17, 2021 (GB) 2116567.5

(51) Int. Cl. A47L 9/16; A47L 5/24; A47L 9/10; A47L 9/12; A47L 9/20

(52) U.S. Cl. CPC A47L 9/1683; A47L 5/24; A47L 9/106; A47L 9/127; A47L 9/1641; A47L 9/20

(57) ABSTRACT

A dirt separator for separating dirt from an airflow in a vacuum cleaner includes a primary separation stage (20), a secondary separation stage (30) and a movable member (40). The primary separation stage has a first dirt collection chamber (22) for storing first dirt removed from the airflow by a first filter comprised in the primary separation stage. The secondary separation stage is downstream of the primary separation stage and has a second dirt collection chamber (32) for storing second dirt removed from the airflow by a second filter comprised in the second separation stage. The movable member is movable relative to the first and second filters to disengage the first dirt and the second dirt from the first and second filters. respectively.

### FIELD OF THE INVENTION

The present invention relates to a dirt separator for separating dirt from an airflow in a vacuum cleaner, and to a vacuum cleaner comprising the dirt separator.

### BACKGROUND OF THE INVENTION

Vacuum cleaners typically employ dirt separators for separating dirt from an airflow entrained by the vacuum cleaner in use. Some dirt separators may utilise filters to aid in dirt separation. Some vacuum cleaners may employ additional filters downstream of the dirt separator to provide additional airflow filtration.

Over time, filter(s) in a vacuum cleaner require regeneration to prolong the life of the filter and help maintain the performance of the vacuum cleaner. This is due to the build-up of dirt or debris on the filter during use of the vacuum cleaner, which puts the filter in a loaded state, thus reducing the filtration capability of the filter. The filter must be cleaned and/or regenerated to restore the filter to a substantially unloaded state and thus restore the performance of the vacuum cleaner.

In some vacuum cleaners, filters are automatically regenerated by a motorised system. Such a system can add cost, complexity, weight and additional power requirements to the vacuum cleaner. In other vacuum cleaners, filters may be removed from the vacuum cleaner and manually regenerated by a user of the vacuum cleaner.

### SUMMARY OF THE INVENTION

According to a first aspect of the present invention, there is provided a dirt separator for separating dirt from an airflow in a vacuum cleaner, the dirt separator comprising a primary separation stage having a first dirt collection chamber for storing first dirt removed from the airflow by a first filter comprised in the primary separation stage, a secondary separation stage downstream of the primary separation stage and having a second dirt collection chamber for storing second dirt removed from the airflow by a second filter comprised in the second separation stage, and a movable member that is movable relative to the first and second filters to disengage the first dirt and the second dirt from the first and second filters, respectively.

Providing the movable member allows both the first and second filters to be at least partially cleared of dirt without being removed from the dirt separator. This may reduce the number of actions that a user of a vacuum cleaner comprising the dirt separator is required to do in order to maintain the vacuum cleaner in good working order. For example, the movable member may be movable relative to the first and second filters in response to a single input by the user.

By providing the movable member, the complexity of any housing in which the first and second filters may be housed can be simplified, compared to a dirt separator in which one or both of the filters must be removed to regenerate the filter(s), since the filters are not required to be easily removable by the user.

The second filter may be substantially cylindrical, having an axis, such as a longitudinal axis if the second filter is elongate, extending along a centreline of the second filter. This may provide a space-efficient arrangement in a vacuum cleaner comprising the dirt separator.

The movable member may be movable relative to the second filter in a direction with at least a component that is parallel to the axis of the second filter. Such an arrangement may help to ensure that the second dirt is disengaged from the second filter across a length of the filter. For example, the movable member may be movable relative to the second filter in a helical manner such that a component of the direction is parallel to the axis of the second filter and another component of the direction is circumferential about the axis of the second filter.

The movable member may be movable relative to the second filter in a direction that is parallel to the axis of the second filter. This may allow for a simpler movable member to be employed, for example in which the movable member is movable linearly.

The movable member may be configured to rotate about the axis of the second filter during movement of the movable member relative to the second filter. For example, the movable member may be movable helically relative to the second filter.

The movable member may be arranged to impact one or more sections of the second filter upon movement of the movable member relative to the second filter.

It has been found that impacting the second filter is an efficient way to restore the second filter to a substantially unloaded state. That is, the movable member impacting the second filter helps the second dirt to disengage from the second filter. The movable member may, for example, flick or knock the second filter to cause the second dirt to disengage from the second filter.

The movable member may impact the one or more sections of the second filter plural times during movement of the movable member relative to the second filter. It has been found that plural impacts to the second filter can increase the amount of the second dirt that is caused to disengage from the second filter, compared to a single impact to the second filter.

The plural impacts to the second filter may occur at different locations on the second filter. It has been found that impacting the second filter at different locations can increase the amount of the second dirt that is caused to disengage from the second filter, compared to plural impacts to the second filter at the same location.

The one or more sections of the second filter may comprise a plurality of pleats extending in a first direction. Providing pleats in the second filter can increase the surface area of the second filter and thus increase filtration efficiency. Providing pleats can also help to increase the rigidity of the second filter.

The movable member may be movable in a direction non-parallel to the first direction. This may allow the movable member to impact, for example flick, at least one of the plurality of pleats during movement of the movable member relative to the second filter. For example, the first direction may be perpendicular to the axis of the second filter such that the pleats extend around the second filter, and the movable member may be movable in a direction that is substantially parallel to the axis of the second filter, such that the movable member is movable across a ridge formed by a pleat to flick the pleat.

The movable member may comprise a main body and one or more protrusions protruding from the main body and arranged to impact the one or more sections of the second filter upon movement of the movable member relative to the second filter.

Providing the one or more protrusions has been found to increase an impact force(s) applied by the movable member to the second filter during movement of the movable member relative to the second filter, which can increase the amount of the second dirt that is disengaged from the second filter.

The one or more protrusions may comprise a rigid material, for example metal or plastic. The one or more protrusions may have greater rigidity than a rigidity of the second filter.

At least one of the one or more protrusions may comprise a longitudinal ridge extending in a direction that is substantially perpendicular, or perpendicular, to a direction of movement of the movable member relative to the second filter. For example, the main body of the movable member may be cylindrical or substantially cylindrical and the at least one protrusion may be in the form of a ring, or part of a ring, protruding inwardly from an inner surface of the main body. The provision of at least one protrusion in the form of a ring or part of a ring may increase the impact force applied to the second filter during movement of the movable member relative to the second filter, compared to a protrusion of lesser length.

At least one of the one or more protrusions may comprise a nub protruding from the main body. For example, the main body of the movable member may comprise a plurality of nubs spaced substantially equally apart. Providing such a plurality of nubs can cause the impact force applied to the second filter by the movable member to be more equally distributed over the second filter, which can provide more even disengagement of the second dirt from the second filter. The provision of nubs, as opposed to longitudinal protrusions, can decrease the force required to move the movable member relative to the second filter, since a smaller surface area of the second filter is contacted by the one or more protrusions.

The first filter may be substantially cylindrical, having an axis, such as a longitudinal axis if the first filter is elongate, extending along a centreline of the first filter. This may provide a space-efficient arrangement in a vacuum cleaner comprising the dirt separator.

The first and second filters may be co-axial. This may provide a space-efficient arrangement in a vacuum cleaner comprising the dirt separator. This may also allow for a simpler movable member design to be employed.

The movable member may be movable relative to the first filter in a direction with at least a component that is parallel to the axis of the first filter. Such an arrangement may help to ensure that the first dirt is disengaged from the first filter across a length of the filter. For example, the movable member may be movable relative to the first filter in a helical manner such that a component of the direction is parallel to the axis of the first filter and another component of the direction is circumferential about the axis of the first filter.

The movable member may be movable relative to the first filter in a direction that is parallel to the axis of the first filter. This may allow for a simpler movable member to be employed, for example in which the movable member is movable linearly.

The movable member may be configured to rotate about the axis of the first filter during movement of the movable member relative to the first filter. For example, the movable member may be movable helically relative to the first filter.

The second dirt collection chamber may be separated from the first dirt collection chamber by a wall. This can prevent upstream airflow between the first and second stages. The wall may comprise the first filter. That is, airflow may flow from the first dirt collection chamber to the second dirt collection chamber via the first filter.

The first dirt collection chamber may form a ring around the second dirt collection chamber, the wall forming an outer wall of the second dirt collection chamber and an inner wall of the first dirt collection chamber. That is, the first dirt collection chamber may be annular, and the second dirt collection chamber may be positioned radially inward of the first dirt collection chamber. This may provide a space-efficient arrangement.

The first filter may comprise a first surface upon which the first dirt accumulates upon filtration of the airflow by the first filter, and the movable member may be movable relative to the first filter to wipe the first surface to disengage the first dirt from the first filter.

It has been found that wiping the first filter is an efficient way to restore the first filter to a substantially unloaded state. That is, the movable member wiping the first filter better causes the first dirt to disengage from the first filter.

The movable member may comprise a wiper blade arranged to wipe the first surface during the movement of the movable member relative to the first filter. Provision of a wiper blade has been found to provide good contact with the first surface to increase an amount of the first dirt disengaged from the first filter during movement of the movable member relative to the first filter.

The first surface may be substantially cylindrical, and the wiper blade may surround, or substantially surround, the first filter. The movable member may be movable in a direction parallel to the axis of the first filter. This can ensure that substantially all of the first surface is wipeable by the wiper blade during movement of the movable member relative to the first filter.

The wiper blade may be formed from a flexible material, for example silicone rubber. The flexible material may be more flexible than the first filter. The wiper blade may be attached to the main body of the movable member and extend inwardly from the main body to contact to first surface of the first filter. This may provide increased contact between the first surface and the wiper blade during movement of the movable member relative to the first filter to increase the first dirt disengaged from the first filter.

The first surface may comprise one or more protrusions extending outwardly from the first surface and arranged to act as a stop for the movable member. That is, the movable member may be movable towards the one or more protrusions to disengage the first dirt from the first filter until the movable member abuts the one or more protrusions.

The dirt separator may comprise a user-actuable actuator connected to the movable member, wherein user-actuation of the actuator causes the movable member to move relative to the first and second filters to disengage the first dirt and the second dirt from the first and second filters, respectively.

Provision of the actuator allows a user to perform a single action to regenerate the first and second filters. The actuator may be provided on an outer surface of the dirt separator to provide easy access to the actuator by the user. The actuator may take the form of, for example, a push-button, toggle, trigger, slidable handle or a rotatable handle. Such actuators may be intuitively actuated by a user.

The actuator may be moveable in a direction parallel to a direction of movement of the movable member. This may allow for the actuator to be integral with the movable member, reducing complexity.

The dirt separator may comprise a cover movable between a closed position in which the cover seals open ends of the first and second dirt collection chambers, respectively, and an open position in which the first and second dirt is dischargeable from the open ends of the first and second dirt collection chambers, respectively.

Provision of the cover allows for the first and second dirt to be discharged from the collection chambers, and for the collection chambers to be sealed by the cover when the dirt separator is being used to separate dirt from an airflow.

The cover may be rotatably connected to the dirt separator. For example, the cover may be connected to the dirt separator by a hinge, providing a simple movement between the open and closed positions.

The cover may comprise an inlet to permit airflow to enter the dirt separator. This may provide a space efficient arrangement.

The actuator may be connected to the cover, and configured so that user-actuation of the actuator causes the cover to move from the closed position to the open position, to allow the first and second dirt to be discharged from the first and second dirt collection chambers, respectively.

Provision of an actuator connected to the cover allows a user to perform a single action to regenerate the first and second filters and to open the cover. Accordingly, a user can disengage the first and second dirt from the first and second filters, respectively, and discharge the first and second dirt from the collection chambers by actuating the actuator. In practice, a user can position a vacuum cleaner comprising the dirt separator above a bin with the open ends of the first and second collection chambers at a lower end of the vacuum cleaner and above the bin, so that, upon actuation of the actuator, the cover moves to the open position and the first and second dirt falls into the bin under gravity.

According to a second aspect of the present invention, there is provided a dirt separator for separating dirt from an airflow in a vacuum cleaner, the dirt separator comprising a separation stage having a dirt collection chamber for storing dirt removed from the airflow by a filter comprised in the separation stage, a cover movable between a closed position in which the cover seals an open end of the dirt collection chamber, and an open position in which the dirt is dischargeable from the open end of the dirt collection chamber; a movable member that is movable relative to the filter to disengage the dirt from the filter, and a user-actuatable actuator connected to the movable member and the cover, wherein the actuator is configured so that user-actuation of the actuator causes the movable member to move relative to the filter to disengage the dirt from the filter, and the cover to move from the closed position to the open position, to allow the dirt to be discharged from the dirt collection chamber.

Provision of the movable member allows the filter to be at least partially cleared of dirt without being removed from the dirt separator. This may reduce the number of actions that a user of a vacuum cleaner comprising the dirt separator is required to do in order to maintain the vacuum cleaner in good working order.

Provision of the cover allows for the dirt to be discharged from the collection chamber, and for the collection chamber to be sealed by the cover when the dirt separator is being used to separate dirt from an airflow. The cover may be rotatably connected to the dirt separator. For example, the cover may be connected to the dirt separator by a hinge, providing a simple movement between the open and closed positions. The cover may comprise an inlet to permit airflow to enter the dirt separator. This may provide a space efficient arrangement.

Provision of the actuator allows a user to perform a single action to regenerate the filter and to open the cover to discharge the dirt. In practice, a user can position a vacuum cleaner comprising the dirt separator above a bin with the open end of the collection chamber at a lower end of the vacuum cleaner and above the bin, so that, upon actuation of the actuator, the cover moves to the open position and the dirt falls into the bin under gravity.

The actuator may be directly connected to the cover. This may provide a simple mechanism for moving the cover. The actuator may be indirectly connected to the cover, for example via the movable member. This may provide a more compact arrangement.

The filter may be substantially cylindrical, having an axis, such as a longitudinal axis if the filter is elongate, extending along a centreline of the filter. This may provide a space-efficient arrangement in a vacuum cleaner comprising the dirt separator.

The movable member may be movable relative to the filter in a direction with at least a component that is parallel to the axis of the filter. Such an arrangement may help to ensure that the dirt is disengaged from the filter across a length of the filter. For example, the movable member may be movable relative to the filter in a helical manner such that a component of the direction is parallel to the axis of the filter and another component of the direction is circumferential about the axis of the filter.

The movable member may be movable relative to the filter in a direction that is parallel to the axis of the filter. This may allow for a simpler movable member to be employed, for example in which the movable member is movable linearly.

The movable member may be configured to rotate about the axis of the filter during movement of the movable member relative to the filter. For example, the movable member may be movable helically relative to the filter.

The movable member may be arranged to impact one or more sections of the filter upon movement of the movable member relative to the filter.

It has been found that impacting the filter is an efficient way to restore the filter to a substantially unloaded state. That is, the movable member impacting the filter causes dirt to disengage from the filter. The movable member may, for example, flick or knock the filter to cause the dirt to disengage from the filter.

The movable member may impact the one or more sections of the filter plural times during movement of the movable member relative to the filter. It has been found that plural impacts to the filter can increase the amount of dirt that is caused to disengage from the filter, compared to a single impact to the filter.

The plural impacts to the filter may occur at different locations on the filter. It has been found that impacting the filter at different locations can increase the amount of the dirt that is caused to disengage from the filter, compared to plural impacts to the filter at the same location.

The one or more sections of the filter may comprise a plurality of pleats extending in a first direction. Providing pleats in the filter can increase the surface area of the filter and thus increase filtration efficiency. Providing pleats can also help to increase the rigidity of the filter.

The movable member may be movable in a direction non-parallel to the first direction. This may allow the movable member to impact, for example flick, at least one of the plurality of pleats during movement of the movable member relative to the filter. For example, the first direction may be perpendicular to the longitudinal axis of the filter such that the pleats extend around the filter, and the movable member may be movable in a direction that is substantially parallel to the longitudinal axis of the filter, such that the movable member is movable across a ridge formed by a pleat to flick the pleat.

The movable member may comprise a main body and one or more protrusions protruding from the main body and arranged to impact the one or more sections of the filter upon movement of the movable member relative to the filter.

Providing the one or more protrusions has been found to increase an impact force(s) applied by the movable member to the filter during movement of the movable member relative to the filter, which can increase the amount of the dirt that is disengaged from the filter.

The one or more protrusions may comprise a rigid material, for example metal or plastic. The one or more protrusions may have greater rigidity than a rigidity of the filter.

At least one of the one or more protrusions may comprise a longitudinal ridge extending in a direction that is substantially perpendicular, or perpendicular, to a direction of movement of the movable member relative to the filter. For example, the main body of the movable member may be cylindrical or substantially cylindrical and the at least one protrusion may be in the form of a ring, or part of a ring, protruding inwardly from an inner surface of the main body. The provision of at least one protrusion in the form of a ring or part of a ring may increase the impact force applied to the filter during movement of the movable member relative to the filter, compared to a protrusion of lesser length.

At least one of the one or more protrusions may comprise a nub protruding from the main body. For example, the main body of the movable member may comprise a plurality of nubs spaced substantially equally apart. Providing such a plurality of nubs can cause the impact force applied to the filter by the movable member to be more equally distributed over the filter, which can provide more even disengagement of the dirt from the filter. The provision of nubs, as opposed to longitudinal protrusions, can decrease the force required to move the movable member relative to the filter, since a smaller surface area of the filter is contacted by the one or more protrusions.

The separation stage may be a secondary separation stage, so that the dirt collection chamber is a second dirt collection chamber, the dirt is second dirt, and the filter is a second filter. The secondary separation stage may comprise any of the features of the secondary separation stage as described with reference to the first aspect of the invention.

The dirt separator may comprise a primary separation stage upstream of the secondary separation stage, the primary separation stage having a first dirt collection chamber for storing first dirt removed from the airflow by a first filter comprised in the primary separation stage. The primary separation stage may comprise any of the features of the primary separation stage as described with reference to the first aspect of the invention.

The movable member may be movable relative to the first and second filters, upon user-actuation of the actuator, to disengage the first dirt and the second dirt from the first and second filters, respectively

The cover may movable between the closed position in which the cover seals open ends of the first and second dirt collection chambers, respectively, and the open position in which the first and second dirt is dischargeable from the open ends of the first and second dirt collection chambers, respectively, and the user-actuation of the actuator causes the cover to move from the closed position to the open position, to allow the first and second dirt to be discharged from the first and second dirt collection chambers, respectively.

According to a third aspect of the present invention, there is provided a vacuum cleaner comprising a dirt separator according to the first aspect or the second aspect of the invention.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a perspective view of a vacuum cleaner;

FIG. 2 is a side view of a handheld unit of the vacuum cleaner of FIG. 1 in a first configuration;

FIG. 3 is a side view of the handheld unit of FIG. 2 in a second configuration;

FIG. 4 is a schematic side view of a portion of the handheld unit of FIG. 2 in a first configuration; and

FIG. 5 is a schematic side view of a portion of the handheld unit of FIG. 2 in a second configuration.

### DETAILED DESCRIPTION

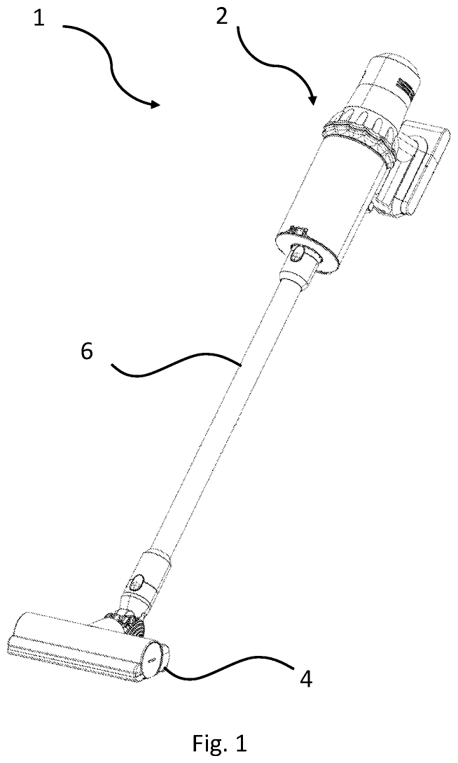

A vacuum cleaner 1 is illustrated in FIG. 1, and comprises a handheld unit 2, a cleaner head 4, and an elongate tube 6. The handheld unit 2 is releasably attached to the cleaner head 4 by the elongate tube 6, and in an alternative configuration the handheld unit 2 can be directly attached to the cleaner head 4.

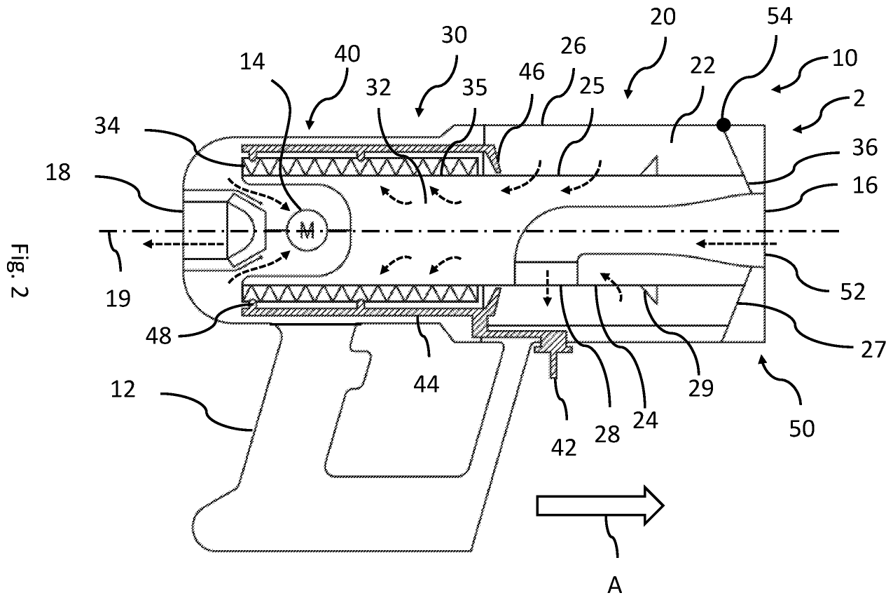

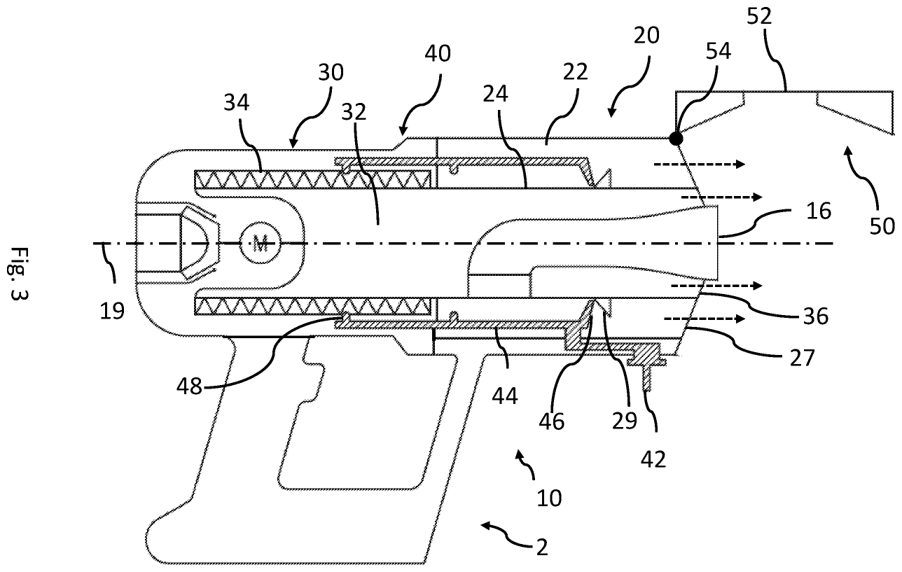

The handheld unit 2 is illustrated in more detail in FIGS. 2 and 3 and comprises a dirt separator 10 for separating dirt from an airflow in the vacuum cleaner 1, a handle 12 housing a battery pack (not shown), and a suction motor 14. The handheld unit comprises an air inlet 16 for receiving airflow from the cleaner head 4, and an air outlet 18 for expelling filtered air from the handheld unit 2. The suction motor 14 is configured to generate an airflow from the air inlet 16 to the air outlet 18, as shown by the dashed arrows on FIG. 2.

The dirt separator 10 comprises a primary separation stage 20 and a secondary separation stage 30. The secondary separation stage 30 is downstream of the primary separation stage 20 with regard to the airflow generated by the suction motor 14.

The primary separation stage 20 is a cyclonic separation stage and comprises a first dirt collection chamber 22 and a first filter 24. The first dirt collection chamber 22 is for storing first dirt removed from the airflow by the first filter 24. During operation of the vacuum cleaner 1, the battery pack provides electrical power to the suction motor 14 to generate the airflow through the vacuum cleaner 1. A surface to be cleaned is agitated by a brushbar (not shown) within the cleaner head 4, such that dirt is entrained within the airflow flowing through the vacuum cleaner 1. Dirt-laden air enters the dirt separator 10 through the air inlet 16 and flows within the first dirt collection chamber 22 in a helical manner.

Larger dirt and debris is removed from the airflow due to centrifugal forces as the airflow flows within the first dirt collection chamber 22. After the larger dirt and debris has been separated from the airflow in the dirt collection chamber 22, the airflow passes through the filter 24 and enters the secondary separation stage 30.

The secondary separation stage 30 comprises a second dirt collection chamber 32 and a second filter 34. The second dirt collection chamber 32 is for storing second dirt removed from the airflow by the second filter 34. During operation of the vacuum cleaner 1, the airflow received from the primary separation stage 30 is received into the second dirt collection chamber 32 and is filtered as the airflow passes through the second filter 34. The second filter 34 removes finer dirt or dust that was able to pass through the first filter 24. Cleaned airflow exits the secondary separation stage 30, then passes the suction motor 14 and is expelled into the atmosphere.

The first dirt collection chamber 22 is generally annular in form and comprises an inner wall 25, an outer wall 26 and an open end 27 at which the first dirt can be discharged from the first dirt collection chamber 22. An opening 28 in the inner wall 25 is arranged to receive airflow from the air inlet 16.

The second dirt collection chamber 32 is generally cylindrical in form and extends through the first dirt collection chamber 22 so that the first dirt collection chamber 22 forms a ring around the second dirt collection chamber 32. The first and second dirt collection chambers 22, 32 are coaxial about a longitudinal axis 19 of the dirt separator 10. The second dirt collection chamber 32 comprises an outer wall 35 that separates the second dirt collection chamber 32 from the first dirt collection chamber 22 and an open end 36 at which the second dirt can be discharged from the second dirt collection chamber 32. The inner wall 25 of the first dirt collection chamber 22 and the outer wall 35 of the second dirt collection chamber 32 are the same wall in this instance. Part of the outer wall 35 that is adjacent to the first dirt collection chamber 32 comprises the first filter 24

The first filter 24 is the form of a shroud. The first filter 24 is arranged in a generally cylindrical manner and is comprised in the inner wall 25. The first filter 24 comprises a plurality of through-holes extending through the inner wall 25, for separating dirt and debris from the airflow received from the opening 28 and for permitting the airflow to pass from the first dirt collection chamber 22 to the second dirt collection chamber 32.

The second filter 34 is in the form of a pleated filter media. The second filter 34 is arranged in a generally cylindrical manner and is comprised in a part of the outer wall 35 that is downstream of the first filter 24. The second filter 34 comprises a plurality of pleats extending around a circumference of the second dirt collection chamber 32, that is, in a direction perpendicular to the longitudinal axis 19 of the dirt separator 10.

As airflow moves through the dirt separator 10, dirt and debris can become trapped in or on the first and second filters 24, 34. To facilitate cleaning of the first and second filters 24, 34, the dirt separator 10 comprises a movable member 40. The movable member 40 is movable relative to the first and second filters 24, 34 to disengage the first dirt and the second dirt from the first and second filters 24, 34, respectively.

A position of the movable member 40 during use of the vacuum cleaner 1 to draw dirt from a surface is shown in FIG. 2. A position of the movable member 40 during cleaning of the first and second filters 24, 34 is shown in FIG. 3, whereby the movable member 40 has moved relative to the first and second filters 24, 34 compared to FIG. 2. As the movable member 40 is moved from the position shown in FIG. 2, to the position shown in FIG. 3, the first and second dirt removed from the first and second filters 24, 34 is stored in the first and second collection chambers 22, 32, respectively.

The movable member 40 is movable by a user in a direction parallel to the longitudinal axis 19 of the dirt separator 10. The movable member 40 comprises a user-actuable actuator 42.

User-actuation of the actuator 42 in a direction as denoted by arrow A causes the movable member 40 to move in a direction parallel to the longitudinal axis 19 of the dirt separator 10 to disengage the first dirt and the second dirt from the first and second filters 24, 34, respectively. The actuator 42 is in the form of a protrusion extending radially outwardly from the first and second collection chambers 22, 32 and may be grasped by a hand of the user.

The movable member 40 comprises a main body 44 that surrounds at least a part of the second filter 34. The actuator 42 is fixedly attached to the main body 44. In this example, the main body 44 and the actuator 42 are a single body.

The movable member 40 comprises a wiper blade 46 arranged to wipe an outer surface of the first filter 24 during movement of the movable member 40 relative to the first filter 24. The wiper blade 46 is fixedly attached to the main body 44 and surrounds the first filter 24. The wiper blade 46 projects from the main body 44 in a radially inward direction towards the outer surface of the first filter 24. In some examples the wiper blade 46 comprises a silicone rubber wiper blade.

The primary separation stage 20 comprises a skirt 29 protruding radially outwardly from the inner wall 25. The skirt 29 acts as a stop for the movable member 40.

The movable member 40 comprises two protrusions 48 each arranged to impact a plurality of the pleats of the second filter 34 during movement of the movable member 40 relative to the second filter 34 to disengage the second dirt. The protrusions 48 are fixedly attached to the main body 44 and each forms a ring protruding radially inwardly from the main body 44 to overlap the pleats at the maximum distance of the pleats from the longitudinal axis 19. In some examples the protrusions are instead in the form of nubs protruding radially inwardly from the main body 44

The dirt separator 10 comprises a cover 50 movable between a closed position, as shown in FIG. 2, and an open position, as shown in FIG. 3. In the closed position, the cover 50 seals the open ends 27, 36 of the first and second dirt collection chambers 22, 32, respectively. In the open position, the first and second dirt is dischargeable from the open ends 27, 36 of the first and second dirt collection chambers 22, 32, respectively.

The cover 50 comprises an opening 52 that defines the air inlet 16 and may be arranged for releasable connection to the tube 6 and/or cleaner head 4, at least when the cover 50 is in the closed position.

The cover 50 is rotatable relative the first and second dirt collection chambers 22, 32 about a hinge 54 by at least 90 degrees to ensure that the cover 50 is not contacted by the first and second dirt during discharge from the first and second dirt collection chambers 22, 32.

The actuator 42 is connected to the cover 50 such that user-actuation of the actuator 42 causes the cover 50 to move from the closed position to the open position, to allow the first and second dirt to be discharged from the first and second dirt collection chambers, respectively.

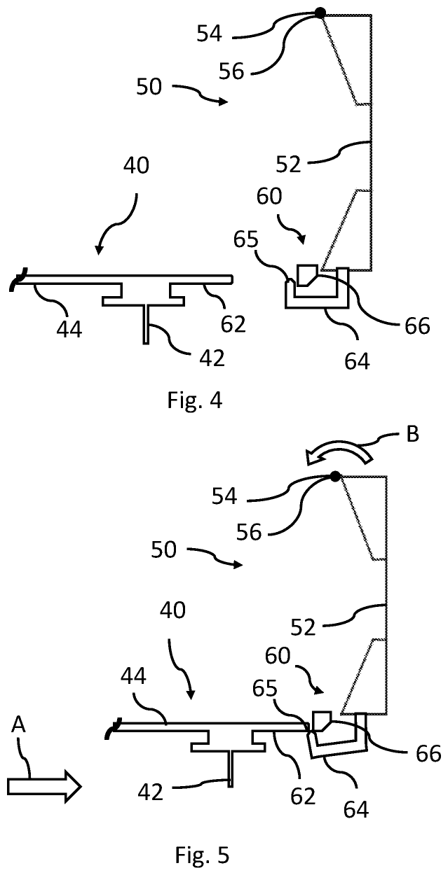

FIGS. 4 and 5 illustrate respective schematic side views of a portion of the movable member 40, the cover 50 and a mechanism 60 for releasably retaining the cover 50 in the closed position. The mechanism comprises a push rod 62, a latching member 64 and a catch 66. The push rod 62 protrudes from the actuator 42 of the movable member 40 in a direction towards the catch 66. The push rod 62 is integral to the movable member 40. The catch 66 is in the form of a protrusion extending radially outward from an outer surface of the dirt separator 10. The latching member 64 is rigidly connected to the cover 50 and is arranged to engage with the catch 66 when the cover is in the closed position to retain the cover 50 in the closed position.

During use of the dirt separator 10 to separate dirt from airflow, the push rod 62 is spaced apart from the catch 66 and the latching member 64 and the latching member 64 is engaged with the catch 66, retaining the cover 50 in the closed position, as illustrated in FIG. 4.

Upon actuation of the actuator 42 in the direction shown by arrow A in FIG. 5, the push rod 62 contacts a contact surface 65 of the latching member 64. The contact surface 65 is arranged at an angle relative to the push rod 62 so that linear motion of the push rod 62 in the direction shown by arrow A to apply a force to the contact surface 65 causes the latching member 64 to flex and disengage from the catch 66, thereby releasing the cover 50 from the closed position, as illustrated in FIG. 5.

The cover 50 comprises a torsion spring 56 about the hinge 54. The torsion spring 56 applies a biasing force B to the cover 50, so that, upon release from the closed position, the cover 50 is moved towards the open position.

The latching member 64 is elastically deformable so that movement of the cover 50 to the closed position causes the latching member 64 to re-engage with the catch 66.

It will be appreciated that in other embodiments any other suitable mechanism for releasably retaining the cover 50 in the closed position may be employed.

In use, the user holds the handheld device 2 over a bin with the air inlet 16 facing downwards and then actuates the actuator 42, causing the movable member 40 to remove the first and second dirt from the filters 24, 34 and to discharge from the dirt collection chambers 22, 32 via the open ends 27, 36, as shown by the dashed arrows on FIG. 3.

The above embodiments are to be understood as illustrative examples of the invention. Further embodiments of the invention are envisaged. For example, the dirt separator 10 may comprise only a single separation stage whereby the primary separation stage 20 is omitted, or the actuator 42 may not be connected to the cover 50, or at least a part of the movable member 40 may be rotatable about the longitudinal axis 19. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the 5 scope of the invention, which is defined in the accompanying claims.

1. A dirt separator for separating dirt from an airflow in a vacuum cleaner, the dirt separator comprising:
a primary separation stage having a first dirt collection chamber for storing first dirt removed from the airflow by a first filter comprised in the primary separation stage;
a secondary separation stage downstream of the primary separation stage and having a second dirt collection chamber for storing second dirt removed from the airflow by a second filter comprised in the second separation stage; and
a movable member that is movable relative to the first and second filters to disengage the first dirt and the second dirt from the first and second filters, respectively.

2. The dirt separator according to claim 1, wherein the movable member is arranged to impact one or more sections of the second filter upon movement of the movable member relative to the second filter.

3. The first separator according to claim 2, wherein the one or more sections of the second filter comprise a plurality of pleats extending in a first direction, and wherein the movable member is movable in a direction non-parallel to the first direction.

4. The dirt separator according to claim 2, wherein the movable member comprises a main body and one or more protrusions protruding from the main body and arranged to impact the one or more sections of the second filter upon movement of the movable member relative to the second filter.

5. The dirt separator according to claim 1, wherein the second filter is substantially cylindrical, and wherein the movable member is movable relative to the second filter in a direction with at least a component that is parallel to a longitudinal axis of the second filter.

6. The dirt separator according to claim 1, comprising a user-actuable actuator connected to the movable member, wherein user-actuation of the actuator causes the movable member to move relative to the first and second filters to disengage the first dirt and the second dirt from the first and second filters, respectively.

7. The dirt separator according to claim 1, comprising a cover movable between a closed position in which the cover seals open ends of the first and second dirt collection chambers, respectively, and an open position in which the first and second dirt is dischargeable from the open ends of the first and second dirt collection chambers, respectively.

8. The dirt separator according to claim 7, wherein the actuator is connected to the cover, and wherein the user-actuation of the actuator causes the cover to move from the closed position to the open position, to allow the first and second dirt to be discharged from the first and second dirt collection chambers, respectively.

9. The dirt separator according to claim 1, wherein the first filter comprises a first surface upon which the first dirt accumulates upon filtration of the airflow by the first filter, and wherein the movable member is movable relative to the first filter to wipe the first surface to disengage the first dirt from the first filter.

10. The dirt separator according to claim 9, wherein the movable member comprises a wiper blade arranged to wipe the first surface during the movement of the movable member relative the first filter.

11. The dirt separator according to claim 1, wherein the first filter is substantially cylindrical, and wherein the movable member is movable relative to the first filter in a direction with at least a component that is parallel to a longitudinal axis of the first filter.

12. The dirt separator according to claim 10, wherein the wiper blade surrounds, or substantially surrounds, the first filter.

13. A dirt separator for separating dirt from an airflow in a vacuum cleaner, the dirt separator comprising:
a separation stage having a dirt collection chamber for storing dirt removed from the airflow by a filter comprised in the separation stage, the filter being substantially cylindrical;
a cover movable between a closed position in which the cover seals an open end of the dirt collection chamber, and an open position in which the dirt is dischargeable from the open end of the dirt collection chamber;
a movable member that is movable relative to the filter in a direction with at least a component that is parallel to a longitudinal axis of the filter to disengage the dirt from the filter; and
a user-actuatable actuator connected to the movable member and the cover,
wherein the actuator is configured so that user-actuation of the actuator causes the movable member to move relative to the filter to disengage the dirt from the filter, and the cover to move from the closed position to the open position, to allow the dirt to be discharged from the dirt collection chamber.

14. The dirt separator according to claim 13, wherein the movable member is arranged to impact one or more sections of the filter upon movement of the movable member relative to the filter.

15. The dirt separator according to claim 14, wherein the one or more sections of the filter comprise a plurality of pleats extending in a first direction, and wherein the movable member is movable in a direction non-parallel to the first direction.

16. The dirt separator according to claim 14, wherein the movable member comprises a main body and one or more protrusions protruding from the main body and arranged to impact the one or more sections of the filter upon movement of the movable member relative to the filter.

17. (canceled)

18. The dirt separator according to 13, wherein the separation stage is a secondary separation stage, the dirt collection chamber is a second dirt collection chamber, the dirt is second dirt, and the filter is a second filter,
wherein the dirt separator comprises a primary separation stage upstream of the secondary separation stage, the primary separation stage having a first dirt collection chamber for storing first dirt removed from the airflow by a first filter comprised in the primary separation stage, and
wherein the movable member is movable relative to the first and second filters, upon user-actuation of the actuator, to disengage the first dirt and the second dirt from the first and second filters, respectively.

19. The dirt separator according to claim 18, wherein the cover is movable between the closed position in which the cover seals open ends of the first and second dirt collection chambers, respectively, and the open position in which the first and second dirt is dischargeable from the open ends of the first and second dirt collection chambers, respectively, and
wherein the user-actuation of the actuator causes the cover to move from the closed position to the open position, to allow the first and second dirt to be discharged from the first and second dirt collection chambers, respectively.

20. The dirt separator according to claim 1, wherein the second dirt collection chamber is separated from the first dirt collection chamber by a wall.

21. A vacuum cleaner comprising the dirt separator according to claim 1.
